(19) United States
(12) Patent Application Publication
(10) Pub. No.: US 2007/0233589 A1
(43) Pub. Date: Oct. 4, 2007

(54) Collateralized acquisition pool investment vehicle

(75) Inventor: Michael Vasinkevich, New York, NY (US)

Correspondence Address: OBLON, SPIVAK, MCCLELLAND, MAIER & NEUSTADT, P.C., 1940 DUKE STREET, ALEXANDRIA, VA, 22314, US

(73) Assignee: Rodman & Renshaw, New York, NY (US)

(21) Appl. No.: 11/395,247

(22) Filed: Apr. 3, 2006

(51) Int. Cl. G06Q 40/00

(52) U.S. Cl. 705/36 R

(57) ABSTRACT

A collateralized acquisition pool investment vehicle includes an issuer, an acquisition pool that includes an amount of funds and/or one or more assets, a plurality of ownership interests in the acquisition pool, a management team and one or more investors and a process for acquiring an asset including capitalizing an issuer with an amount of funds, engaging a management team to identify one or more acquisition targets, and acquiring the asset identified by the management team by consensus of the ownership interests of the issuer.

### BACKGROUND OF THE INVENTION

1. Field of the Invention

The invention relates to a collateralized acquisition pool investment vehicle that includes an issuer, an acquisition pool that includes an amount of funds and/or one or more assets, a plurality of ownership interests, a management team and one or more investors. The invention further relates to a process for acquiring an asset such as an operating business that includes capitalizing an issuer with an amount of funds, engaging a management team to identify or provide one or more acquisition targets, and acquiring the acquisition target identified by the management team by agreement of the ownership interests of the issuer. The invention further relates to a system for carrying out an acquisition of an asset with a collateralized acquisition pool investment vehicle.

2. Description of the Related Art

The sale and resale (e.g., merger and acquisition), reorganization, capitalization and realignment of assets by investors are important elements of the commercial development that takes place within a market economy. The purchase of different assets under disparate control and/or ownership and having separate service infrastructures in order to combine (e.g., consolidate) the assets under a single controlling interest is a way for investors to improve the profitability of the assets. By combining assets, both tangible and intangible, into a single controlling interest, greater efficiency can be realized, such as the efficiency derived from economy of scale. For example, where a plurality of assets may each require separate and distinct maintenance and service infrastructures when under separate and independent ownership, when combined, wasteful redundancy is eliminated by using a shared service and/or maintenance infrastructure.

Combining a plurality of assets under a single ownership interest can eliminate the need for separate service, maintenance and/or administration infrastructures for a plurality of assets. Thus, combining different assets so that the assets can share the same infrastructure reduces redundancy and leads to lower costs.

Many assets, including assets that may be described as operating businesses, require certain operating elements in order to function effectively and to maintain their status as on-going businesses. Such operating elements are generic in character and include, for example, sales, administration (e.g., human resources, accounting, etc.), logistics, and certain physical asserts such as leased premises, and information systems, etc. Without these operating elements no infrastructure would be present to take care of daily operating necessities such as payroll, financial planning, and succession planning. Although such operating elements are indispensable for operating an asset (e.g., a business such as a corporation having employees, customers, and products and/or services that generate income through sales), when considered independently, these operating elements have a generic character. Thus, an asset's administration element (e.g., accounts payable and payroll) can be interchanged with the accounts payable and payroll functions of a different asset.

Even though such operating elements have substantial generic character their on-going maintenance requires significant resources and capital. For example, the information services infrastructure of even a small asset such as a small business must be capable of secure, reliable and modern operations. The cash flow and capital requirements needed to maintain an information services infrastructure (e.g., a necessary business element) directs significant resources away from the asset's fundamental purpose (e.g., its business goals) and thereby hampers the asset's ability to grow and/or otherwise may detrimentally affect the value of the asset.

Synergism can be realized when a plurality of assets are combined. Synergism may occur between assets that are positioned horizontally or vertically, or both horizontally and vertically. For example, a first asset may be a supplier of a particular resource, manufactured good, or service that has a generic or commodity characteristic (e.g., paper). A second asset positioned in a vertically higher orientation to the first asset may transform the generic and/or commodity product produced by the first asset in a manner that substantially increases the value of the product (e.g., a publisher). Combining the first and second assets in a business combination may provide a means of improving the profitability of the second asset (e.g., by reducing the costs of paper used by the publisher) while concurrently improving the profitability of the first asset (e.g., by increasing the profit margin associated with the sale of paper products). Combining the unique knowledge and technology characteristics of the first and second assets may also increase the profitability of the resulting business combination by an amount that is greater than what would ordinarily be expected if the profitability of the assets were combined cumulatively.

Horizontally positioned assets can also benefit from combination and/or integration. For example, a first asset and a second asset, each operating in different industries, may be able to improve their business prospects by combining. A horizontal business combination may have a value greater than the cumulative value of the uncombined assets. For example, by combining horizontally, two assets can make use of the same supply, maintenance and/or sales systems, thereby increasing the overall profitability relative to the two assets considered separately.

In order to take advantage of the synergisms and economies of scale mentioned above, it is important that investors be able to purchase and combine assets in an efficient manner. One way to combine assets is for one asset to make an outright purchase of another asset (e.g., a first asset purchases a controlling amount of the voting stock of a second asset). This strategy may not work when the ownership interests of the asset targeted for purchase (i.e., the second asset) does not feel a business combination is in its best interests. This strategy may also be complicated when the target asset is publicly owned or where different ownership interests and/or financial goals must be satisfied in order to obtain agreement to complete a purchase.

Privately held companies, e.g., those companies that are not publicly traded on a stock exchange and whose ownership interests are held by only a limited number of individuals and/or parties, may be easier to acquire because the number of ownership interests (e.g., investors, stockholders etc.) is much lower and negotiating with these interests is less burdensome. However, privately held companies often do not wish to publish or make publicly available the same depth of detail with respect to financial information and/or business planning that is available for publicly traded companies. Thus, an extra dimension of risk is added to the purchase of a privately held asset in comparison to an asset which trades as a publicly traded stock.

The funds necessary to complete the purchase of the target asset(s) must be available before an investor can purchase an asset or before one asset can purchase another asset, e.g., the asset over which control is desired. It is not unusual for a target asset (e.g., an asset under consideration for purchase) to have a valuation that is greater than one billion dollars. Generally the valuations of the assets that may be handled with an acquisition pool purchase range from about $25 million to over $1 billion. With the exception of investment pools, only very few individual investors have the resources to consummate such a purchase or to otherwise secure the financing necessary in order to purchase the asset. Thus, in order to undertake a substantial purchase it is necessary to first assemble the resources (e.g., money) needed in order to purchase the asset. Investment pools offer an investor the ability to take part in a particular purchase in a manner that spreads the risk over a number of different investors.

Thus, there is a need for a means, system, product and/or method by which an asset, such as an operating business or a unit of an operating business, can be combined with another asset and reorganized to realize synergistic combinations through one or more of horizontal integration, vertical integration and economy of scale.

One way to combine assets is for a first asset to purchase a second asset and subsequently integrate the second asset to form a new business asset. This may be carried out in a number of ways. Perhaps the most common way is for the ownership interest of the first asset to obtain the ownership interest of the second asset, for example by exchanging funds or value for the ownership interest of the second asset. Thus, the first asset acquires the second asset in a manner which gives the first asset the right to direct the operation and business planning of the second asset, for example through a controlling interest (e.g., majority) of the second asset's stock. Another way to combine assets is for the first and second assets to voluntarily combine and thereby create a new asset. The ownership interests in the newly created asset are split between the ownership interests of the original assets based on, for example, proportional representation in the stock of the newly created asset. Subsequent to the combination of the assets, the ownership interests may collectively decide how to manage the asset.

The purchase and/or combination of different business assets is often undertaken by a party who does not have any existing business interest in the particular business asset to be purchased or combined. The party wishing to acquire the asset must, of course, be capable of collecting and managing the funds necessary for obtaining the ownership interests of the parties in control thereof. As was mentioned above, only a limited number of individuals, organizations and/or businesses etc. are capable of assembling the capital needed in order to purchase assets of high value.

When only a single entity is involved in the purchase of a particular asset, that entity undertakes all of the risk associated with such a purchase (e.g., the risk is not spread to others). Concentrating the risk to a single investor may result in a greater risk than is warranted by the reward that may accompany the acquisition of the asset. In order to spread the risk and to make the acquisition of certain assets possible for a greater number of investors (e.g., individuals, entities, businesses etc.), the resources of several different parties may be combined to form a pool that has a greater asset-purchasing capability in comparison to the resources of a single investment party.

When pooled resources are used to carry out the purchase of business assets, a substantially greater number of businesses and/or individuals (e.g., investors) may be capable of participating in the purchase of the business assets. In some instances a group of investors may form a pool for the purpose of carrying out the purchase and combination of assets for the purpose of investment or speculation without having identified any particular target asset in advance. Such a group of investors may include both individual investors (e.g., private individuals) and businesses such as corporations, and/or investment funds that represent the interests of a large group of individual or institutional investors. By combining the resources of many individuals and or different parties, it is possible to form a pool of funds that is sufficient for carrying out the purchase of even very high valuation assets.

Special purpose acquisition companies (also known as blank check companies or SPACs) are one means by which the purchase of business assets has been carried out by groups of investors. By using a special purpose acquisition company a group of investors (e.g., a group that may include individual investors) provides an amount of money in exchange for an ownership interest in certain assets. Such a special purpose acquisition company may be organized by one or more financial advisors or placement agents, e.g., an investment bank (e.g., the organizer). The organizer brings together a group of investors having sufficient resources (e.g., funds) for forming a fund pool. The organizer may also take responsibility for engaging a group of experts, consultants and/or managers to carry out the asset purchase and to manage and/or restructure the assets acquired (e.g., eliminate redundancies such as redundancy in internal infrastructure). Confluence Acquisition Partners I, Inc. is an example of a special purpose acquisition company (Form S-1 dated Jul. 8, 2005 for Confluence Acquisition Partners I, Inc., is incorporated herein by reference in its entirety).

A special purpose acquisition company may engage a management team to carry out the purchase and/or reorganization of certain business assets. The management team identifies one or more business assets for purchase and, in return for the management team's expertise and services, the management team receives a portion of the ownership interest of any business asset that is purchased with the funds provided by the investors. Due to certain regulatory limitations however, the management team is limited to choosing only those business assets that are new to the management team. For example, the management team may not carry out the purchase of a business asset according to a preconceived notion, e.g., the management team may not carry out a business plan that was conceived before being engaged by the organizer of the fund pool (e.g., the special purpose acquisition company). The regulatory restrictions on special purpose acquisition companies severely limit their usefulness and make it more difficult to obtain maximum value for a management team's experience in a particular industry or with a particular business asset.

Special purpose acquisition companies are regulated through the Securities and Exchange Commission (SEC). Special purpose acquisition companies are “listed” investments that must meet substantial regulatory and financial guidelines set by the SEC. Thus, special purpose acquisition companies are limited in scope to certain activities. The restrictions of special purpose acquisition companies significantly limit their usefulness for carrying out acquisitions and/or business asset purchases.

Other substantial limitations of special purpose acquisition companies include a requirement that any asset purchase carried out by the pool must utilize a majority of the funds in the fund pool of the special purpose acquisition company. This requirement effectively results in the special purpose acquisition company being able to purchase only a single asset. Generally, in special purpose acquisition companies there is a requirement that at least 80% of the value of the acquisition pool be disbursed in a transaction. While it may theoretically be possible to carry out more than one acquisition (e.g., acquire more than one asset) with a single disbursement of 80% or more of the special purpose acquisition company's funds, in practice it is very difficult to coordinate and negotiate multiple asset purchases with a special purpose acquisition company. Thus, the asset targeted for purchase by the special purpose acquisition company is placed in a strong negotiating position because the amount of funds available to the special purpose acquisition company and the timing of its disbursement are known to the asset (e.g., known to the management and/or owners of the asset).

For example, a special purpose acquisition company may be restricted by a requirement that at least 80% of the fund pool must be spent on a business asset purchase within a certain period of time (e.g., one to two years). Special purpose acquisition companies are listed companies. A business (e.g., target asset) that is the target of a purchase may determine the amount of funds available for the special purpose acquisition company to complete a purchase from publicly available information. A target asset will also be able to determine other conditions such as the minimum amount of expenditure of funds in the fund pool must be met to be in compliance with the requirements of special purpose acquisition company rules.

This places the special purpose acquisition company in a very weak negotiating position. The target asset (e.g., the business asset under consideration for purchase) will know the maximum amount of funds available in the fund pool and will also know the minimum amount which must be spent from the fund pool in order to meet the requirements of the special purpose acquisition company. Further, the target asset will know the timeline (e.g., the date by which the fund pool must be spent in order to meet the conditions of the special purpose acquisition company). This results in a substantial loss of negotiating power for the special purpose acquisition company.

### SUMMARY OF THE INVENTION

Accordingly, it is one object of the present invention to provide a method by which a group including one or more investors may pool an amount of funds to purchase one or more assets in a manner that does not restrict the scope of assets that may be purchased.

It is a further object of the invention to provide a collateralized acquisition pool investment vehicle that includes one or more investors, a management team, current and future ownership interests of the investors and the management team, a fund pool and an issuer.

It is a further object of the invention to provide a method by which one or more assets may be acquired with a collateralized acquisition pool investment vehicle.

A further object of the invention is a system that includes carrying out the purchase of a business asset with a collateralized acquisition pool investment vehicle.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 shows a high level description of some portions of an embodiment of the process of the invention;

FIG. 2 shows a high level description of some portions of other embodiments of the invention;

FIG. 3 shows a high level of the flow and change in ownership interests and funds in one embodiment of the invention;

FIG. 4 illustrates a computer system upon which an embodiment of the present invention may be implemented.

### DETAILED DESCRIPTION OF THE PREFERRED EMBODIMENTS

Collateralized Acquisition Pool Investment Vehicle

One aspect of the invention is a collateralized acquisition pool investment vehicle (i.e., the investment vehicle). The investment vehicle includes at least the following components: one or more investors, a management team, the ownership interests of the investors and the management team, an amount of funds (e.g., an acquisition pool), and an issuer.

The properties and characteristics of each of the aforementioned components of the collateralized acquisition pool investment vehicle may change over time (e.g., during the life of the investment vehicle). For example, an investment vehicle may initially have a group of a first number of investors. Over time the number of investors in the investor component of the investment vehicle may increase or decrease. Moreover, the character of the ownership investors and the investor's interest (e.g., the ownership interests of the investors) may change over time.

The life of the investment vehicle includes the period of time beginning at the inception and/or organization of any one of the components of the investment vehicle through the completion of the investment vehicle's purpose (e.g., the successful purchase, acquisition, reorganization and/or merger of one or more business assets) or alternatively to the point at which the investors release funds to the issuer.

The components of the investment vehicle described below may be used in the method and/or system which are embodiments of the invention described below and likewise any one of the components of the methods and/or systems described below may be used in, modify and/or describe the components of the investment vehicle.

In addition to the components described below, the investment vehicle may contain any additional number of optional components. For example, the investment vehicle may include a bank guarantee in addition to the amount of funds. The investment vehicle may also contain other components that help to carry out a function of the investment vehicle, such as one or more consultants. Additional components may also include, for example, an insurance policy to guarantee a particular rate of return to the investors. The insurance policy may be connected to the other components of the investment vehicle through a guarantee by one or more of the management team and/or a third party backed by the amount of funds and/or value of the acquisition pool.

The investment vehicle must include one or more investors. The investors may be individual investors or the investors may be represented collectively as a group by a representative. For example, the investors may include a group of individuals and/or legal entities that is capable of contributing funds to an acquisition pool. However, the investors are not required to participate in the investment vehicle other than as passive investors. In one embodiment of the invention the investors provide funds to an acquisition pool, however the investor's interests are represented by a third party who may optionally be an investor in the investment vehicle.

The number of investors is not limited. The investment vehicle may contain a small number of investors each capable of contributing a substantial amount of money (e.g., greater than $1 million) to an acquisition pool (e.g., such as the acquisition pool or the amount of funds of the investment vehicle). The investment vehicle may include a large number of investors each of which is independently capable of contributing either a large or a small sum of funds to the acquisition pool.

One purpose of the investors is to provide funds necessary in order to form an acquisition pool. Typically, the funds made available by the investors are in the form of cash and/or other liquid assets that may be easily transferred between parties in order to carry out a purchase. Such liquid assets may be represented as bank drafts. Another purpose of the investors is to provide supervision of the investment vehicle. In one embodiment of the invention, the investors review and decide whether certain business proposals and/or proposed investments are acceptable for the investment purposes of the investment vehicle.

The investment vehicle includes an ownership interest component. The ownership interest may include both current ownership interests and future ownership interests. The ownership interests may represent a proportional amount of the value and/or obligations of the investment vehicle. For example, an investment vehicle that includes an acquisition pool having a value of $10 million may be represented by ten current ownership interests. If the investment vehicle has no obligations, the value of each ownership interest in the investment vehicle is $1 million. Of course, the value of the ownership interest may exceed or be less than the readily quantifiable liquid assets and/or other assets which may be part of the investment vehicle's acquisition pool. For example, an investment vehicle that includes a number of investors known to have certain insight in a particular industry may have a value greater than the total value of funds in the acquisition pool (e.g., a premium) due at least in part to the added value associated with the knowledge of the investors.

The investor's ownership interests may change in character and/or quantity over time. In one embodiment of the invention the investors may initially have both current and future ownership interests. The ownership interests of the investors may be obtained by an exchange of the investor's funds or other consideration for the ownership interests. The current ownership interests may include a security such as a preferred security. The security and/or preferred security may take the form of registered stock, unregistered stock, secured notes, secured debt, unsecured debt, and/or any convertible security. Usually, the investor's ownership interest arises after the investor has provided funds to the investment vehicle to form an acquisition pool. In the absence of the provision of funds for the investment vehicle's acquisition pool, the investor may not have a current ownership interest. In contrast, the ownership interest of other parties may arise before any contribution is made to the acquisition pool. For example, a placement agent responsible for organizing and/or aiding in the formation of the investment vehicle may obtain either or both of a current and a future ownership interest in the investment vehicle for services rendered instead of making a direct contribution of funds to the acquisition pool. Likewise, the management team (discussed below) may obtain any of a current or future ownership interest in the investment vehicle with or without an initial contribution to the acquisition pool, preferably the management team makes a substantial initial contribution to the acquisition pool to obtain both a current and a future ownership interest, subject to certain limitations on the beneficial exercise of the interests.

The ownership interests are accompanied by preferred voting rights giving the investors or the holders of the current ownership interests a right to participate in determining whether or not the investment vehicle should undertake the purchase of a particular business asset. In one embodiment of the invention, the investment vehicle includes different classes of current ownership interests. The classes of ownership interest may be accompanied by different classes and/or seniority of voting rights. A highest class of voting rights may include the right to vote an extraordinary number of votes and/or may include a right to veto a business proposal or cancel an extraordinary number of votes.

The votes of the ownership interests function to provide a means by which the investors can reach agreement and determine whether the acquisition of a particular business asset should be undertaken by the investment vehicle. Thus the investor component, the ownership interest of the investor, and the amount of funds provided by the investor are related and connected to one another. In embodiment of the invention, the ultimate purpose and function of the investment vehicle is carried out only when each of the aforementioned components interacts such that the investor's ownership interests representing the investor's contribution (e.g., the amount of funds provided for the acquisition pool) is dedicated or encumbered to carry out the purchase of business assets that are acceptable to the investor.

As was mentioned above, both current and future ownership interests may be components of the investment vehicle. Future ownership interests may include, for example, warrants for the future purchase of a current ownership interest in the investment vehicle. Normally, the date upon which a future ownership interest may be voluntarily or involuntarily changed to a current ownership interest (e.g., by the exercise or conversion of the future ownership interest to a current ownership interest) is specified as a condition of the future ownership interest. For example, a future ownership interest may include a warrant for the purchase of a current ownership interest such as common or preferred stock. The future ownership interest may vest, mature, or become exercisable only after a period of time or within a particular window of time defined by the future ownership interest. In certain instances the future ownership interest includes an exercise price (e.g., strike price) at which the future ownership interest may be exercised. The exercise or strike price of the future ownership interest may represent a fractional amount of the current ownership interest value (e.g., unit value and/or share value). In other embodiments, the exercise or strike price of the future ownership interest is set by a formula that correlates the rate of return provided by the investment vehicle with variables such as the time passing since the investor's initial contribution of funds and other variables.

The future ownership interest, in one embodiment, provides a means by which investors may obtain an additional return on the amount of the funds provided to the acquisition pool as part of the investment vehicle. The future ownership interest is structurally a part of the investment vehicle through its connection to any one of the investment vehicle's financial performance, the investor's ownership interest, the investor, and the amount of funds provided by the investor.

A further component of the investment vehicle is an issuer. An issuer is an entity which may permit the investors to utilize a public equity corporation to carry out the investment goals of an initially private investment. In a preferred embodiment, the issuer is a corporation having a publicly traded stock trading on a U.S. or foreign securities market (e.g., AIM, NYSE, NASDAQ, AMEX, Bulletin Board, PORTAL, or any regional or foreign exchange). The issuer may be a corporation that is controlled by a management team (discussed below). Thus, in one embodiment of the invention, a management team may own or control the issuer which is a component of the investment vehicle. The issuer, as a component of the investment vehicle, is connected to the other components of the investment vehicle through the ownership interest of the investors, the management team and the amount of funds provided by the investors in exchange for ownership interest in the investment vehicle. The issuer may have possession of the amount of funds provided by the investors (e.g., the acquisition pool) to the investment vehicle. Although the amount of funds may be in the possession of the issuer, control is retained by the investors through the investors' ownership interest (e.g., current ownership interest) and through the investors' preferred voting right which makes the release of the funds in the acquisition pool contingent upon the investors' approval.

The investment vehicle is made by combining the components mentioned above. The combination of the components may be carried out contractually. A contractual assembly may condition the investment vehicle and/or any component thereof on the concurrent existence of the other components. Once fully assembled (when all components of the investment vehicle are present), proportional interests in the investment vehicle may be sold and/or exchanged between the investors or between investors and other parties. Thus, in one embodiment, the investment vehicle becomes an liquid asset after all components of the investment vehicle are in place and are connected to one another as mentioned above.

Method for Acquiring Business Assets

Another aspect of the invention includes a method for acquiring one or more assets (e.g., an acquisition). An acquisition may be undertaken to reorganize, merge, or reengineer the asset subsequent to its purchase. The method of the invention may include a step of changing the structure of the asset after acquisition and may include merging the acquired asset with another asset purchased or acquired using the invention method. Any of the components of the collateralized acquisition pool investment vehicle described above may be used to carry out the method of the invention.

The method includes (i) capitalizing an issuer, (ii) engaging a management team, and (iii) carrying out the purchase or acquisition of a business asset.

Capitalizing includes providing funds or a guarantee of funds to an issuer (see description below) through, e.g., the collateralized acquisition pool investment vehicle described above, in exchange for an ownership interest in the issuer and/or the collateralized acquisition pool investment vehicle. For example, in exchange for an amount of funds, the issuer may issue a new security to an investor. The new security represents an ownership interest such as, for example common stock, preferred stock, unregistered stock and/or convertible securities such as secured and unsecured notes and debentures. Alternatively the issuer may reclassify any existing security as a new security such as a common stock, preferred stock, unregistered stock and convertible securities such as secured and unsecured notes and debentures.

The new security may have a special voting right that is distinct from any voting right of the common stock or other stock of the issuer existing before the new security is issued, such as before a management team obtains a controlling interest in the issuer. The new security may have senior and subordinate voting rights. The senior voting rights may be in the form of a greater proportional representation of certain investors' ownership interests and/or the senior voting rights may provide a superior right to vote, and/or a right to vote first and/or a right to vote after some or all of the other ownership interests have voted.

In a preferred embodiment, the new security issued by the issuer in exchange for funds (e.g., those investor funds to be used as a part of the collateralized acquisition pool investment vehicle) is a convertible security having a preferred voting right. The preferred voting right of any new security, such as a convertible security issued in exchange for an investor's funds, gives the investor or the holder of the convertible security a superior voting right with respect to the issuer's use of the funds obtained in exchange for the security. The preferred voting right may also give the holder of the convertible security other rights such as a superior right to dividends and/or a superior creditor position against the issuer.

The capitalizing may include obtaining funds from one or more investors. The investors may include any investors, e.g., individual investors, corporations, and/or fractional or whole interests of one or more groups of investors. Groups of investors may be represented by one or more of an investment agent, a placement agent, a mutual fund, a hedge fund, a private equity arrangement, or an investment fund. Preferably, the investor exchanges funds for a new security.

The amount of capital used for the capitalizing is not limited. Preferably, the amount of capital is at least $10,000,000, more preferably, at least $40,000,000, preferably the amount of capital is not greater than the value of all assets in a particular asset class under consideration for purchase by the collateralized acquisition pool investment vehicle. Preferably, each investor provides at least $1,000,000 in capital.

The capital obtained from the investors in exchange for the new security (e.g., a preferred security having preferred voting rights) is held in a trust or a controlled account in the name of the issuer solely for the benefit of a collateralized acquisition pool investment vehicle organized to undertake a business asset acquisition (e.g., solely for the ultimate benefit of the investors who provided the funds for the capitalizing). The term “trust” is used herein to denote a particular legal arrangement whereby the funds provided by the investors under the control of another party even though the funds are in possession of the issuer. A controlled account serves a similar purpose except that the finds are not controlled by a third party but are instead subject to certain restrictions which make the disbursement and/or release of funds from the account impossible unless certain conditions are met. The terms “trust” and “controlled account” may be used interchangeably herein.

For example the issuer may issue a preferred security having a preferred voting right. The preferred voting right is available only to the holders of the preferred security. Other holders of other securities and/or stock in the issuer do not have the same voting right as holders of the preferred security issued in exchange for the capital.

The capital of the trust may be releasable to the issuer or another party upon a vote of the holders of the preferred security having a preferred voting right. The issuer does not otherwise have a right to use the controlled account and/or the trust for ordinary business purposes. Alternatively, the controlled account may be one that pays a periodic interest payment or dividend. Because the capital is in a trust or a controlled account, and was obtained in exchange for the preferred security having a preferred voting right, it is protected from the general creditors of the issuer. The issuer may not draw upon the capital fund (e.g., the trust and/or controlled account) or otherwise utilize the capital fund as security for a loan or other venture.

The funds held in the trust (e.g., the controlled account) may be invested in short term investments by a trustee appointed and/or assigned by the investors or a placement agent. Any return or gain on the funds realized while the funds are held in trust is paid to the investors on a pro rata according to the number of shares held by the investors. The funds provided by the investors and present in the trust may be invested in ordinary short term securities paying an interest rate (e.g., coupon rate). The interest collected from the invested funds may be periodically distributed to the investors (i.e., the holders of the preferred security having the preferred voting right) or retained by the trust for the purposes of carrying out the goals of a collateralized acquisition pool investment vehicle.

There is no restriction on the nature of the short term investment that is accessible with the funds in the trust or the controlled account of the issuer. In a preferred embodiment, the funds are invested in short-term instruments paying a periodic interest or dividend such as T-bills or corporate bonds having a Moody rating of at least AAA+. Most preferably the funds are invested in short-term government securities paying a periodic interest. In other embodiments, the funds may be invested or leveraged by the investors in other ventures. However, once the investors have voted to release funds to the issuer (see below), the investors are no longer able to leverage the funds in trust.

In another embodiment, any return on the funds in trust is retained by the trust or the controlled account held by a collateralized acquisition pool investment vehicle and is not distributed to the investors. In still another embodiment, a portion of the periodic payments is distributed to one or more placement agents.

The issuer is preferably a company having a stock publicly trading on a U.S. or foreign securities market (e.g., AIM, NYSE, NASDAQ, AMEX, Bulletin Board, PORTAL, or any regional or foreign exchange). More preferably the issuer is a company having a publicly traded stock trading at a quoted stock price on a national securities market. The issuer may be a company such as a stock company having a publicly traded stock that is controlled by a placement agent, an affiliate of a placement agent, or by a management team and may be a company that will be acquired by a collateralized acquisition pool investment vehicle.

In exchange for the investor's funds (e.g., as a part of the capitalizing), the investors receive a current and future ownership interest. The current ownership interest may be, for example, a preferred security such as a preferred note or a preferred stock having a preferred voting right (e.g., a voting right which permits the investors to determine whether or not to release funds in a trust or controlled account to purchase a particular asset).

The investors' interests may be represented as ownership interests, for example the ownership interests created by a collateralized acquisition pool investment vehicle. The ownership interests of the investors may initially (e.g., during the time the funds are held in trust) include legal title to the funds and/or any rights flowing therefrom. Preferably, the investors provide the issuer with funds in exchange for a current ownership interest such as a preferred security. Thus, once an issuer has obtained an investor's funds, the investor no longer has legal title to the funds. However, in exchange, the investor has received a preferred security such as a security which provides a periodic payment. The ownership interests of the investors may have the properties of a convertible security (having either or both of current and future ownership interests).

The amount of beneficial ownership interests that may be held by any one investor may optionally be limited. The ownership limitation may limit all or any particular owner to a certain portion of the outstanding preferred and/or convertible securities. In one embodiment, a single investor may be restricted to having no more than 50%, preferably 40%, more preferably 30%, even more preferably 20%, especially preferably no more than 10%, even more especially preferably less than 5%, and most preferably no more than 4%, 3%, 2% or 1% of the total ownership interest in the collateralized acquisition pool investment vehicle through the amount and/or future ownership interests and/or the preferred and/or convertible securities. In another embodiment, the investor may hold any amount of ownership interest, however the investor is permitted to vote only a portion of the votes associated with the ownership interest. For example the investor may own 60% of the total ownership interests ordinarily representing 60% of the voting rights, however the aforementioned restriction limits the investor's total voting share to no more than, e.g., 10% of all votes that may be cast, preferably no more than 20%, more preferably no more than 30%, and even more preferably no more than 40%.

In another embodiment, the investor's funds may be exchanged for a convertible debenture that may include an unsecured note. The funds provided by the investors to the issuer and invested in a trust or held in a controlled account may yield a stream of payments such as the income generated by short term investments. In a preferred embodiment, all of the income generated by the trust is returned to the investors in the form of periodic payments. The periodic payments may occur on a regular basis and may coincide with the receipt of interest obtained from the short-term investments in which the funds (e.g., the controlled account) are invested.

The convertible security representing the investors' interests may be a senior secured convertible note (e.g., a current ownership interest) issuable under an indenture pursuant to Regulation D of the Securities Act of 1933, as amended, and a common stock purchase warrant (e.g., series A warrant) issuable in connection with a warrant agreement (e.g., a future ownership interest) pursuant to Regulation D of the Securities Act (collectively, a “unit”). Each unit may include a note in a certain principal amount and a warrant to purchase shares of the common stock at a certain price. For example, the units may be in any amount such as $10,000, $20,000, $50,000, $75,000, $100,000, $1,000,000 and the like. The purchase price of the unit may be allocated on the books and records of the issuer to the note and the warrant.

The investors vote to determine when the funds provided by the investors should be released to accomplish an asset purchase. Such an action is known as conversion of the note into an ownership interest (e.g., a stock having a preferred voting right) to the issuer. Conversion is not necessarily a change from a convertible note to common stock. Conversion may include only a release of funds (e.g., the trust fund or the controlled account investment paying a periodic revenue stream) so that the issuer may carry out an acquisition with the investor retaining an ownership interest in the form of a convertible security such as a convertible note which is securitized with the assets of the issuer including, in one embodiment, the funds provided by the investor and not used or dedicated to the purchase of any target acquisition.

As noted above, release of the funds from the trust (e.g., controlled account) to the issuer does not require conversion of the convertible security to an ownership interest in the form of stock. Instead, the investors may elect to maintain their position in the form of a convertible security such as a note. This provides an advantage to the investor in case the issuer enters bankruptcy or is otherwise in default on the note and/or the security. Thus, an investor's ownership interest in a collateralized acquisition pool investment vehicle (e.g., as represented by proportional ownership interest in the issuer) is not necessarily an interest as a stock holder. Instead, the investor's interest may be in the form of a secured note thereby providing the investor with additional protection against insolvency of the issuer. The note may provide for conversion to an ownership interest in the form of stock at a later date or upon the investor's individual preference or upon a majority vote of all investors. Conversion of the note to stock (e.g., common stock, preferred stock and/or unregistered stock) may occur on a fixed timetable or may occur upon election by the investor (e.g., the holder of the convertible note) or by a majority vote of all holders of convertible notes.

The future ownership interest is one that may be marketable as a traded security. The future ownership interest may have conditions that affect the underlying value of the ownership interest and/or its value as a traded security. For example, the future ownership interest may entitle the investor to a certain portion of the ownership of any investment carried out with the funds exchanged for the ownership interest. In one embodiment, the future ownership interest is a warrant entitling the investor or holder of the warrant with a right to purchase a certain number of shares or notes of the issuer, or otherwise purchase a proportional interest in the investment made with the inventor's finds.

The warrants may have a defined life, for example a time within which they must be exercised or converted to a current ownership interest (e.g., 1 month, 1 quarter, 1 year or any multiple such as 2, 3, 4, 5, 6, 7, and 10 of any of the aforementioned periods). The warrant may be subject to a one-time right of cancellation by the issuer on notice after the maturity date of a convertible security (e.g., any date by which the finds in trust must be released to complete an asset purchase) if no acquisition or business combination is identified by a management team.

As was mentioned above, the ownership interests of the investors have certain voting rights. The preferred voting rights of the preferred security are shared among all of the investors who provided funds to the collateralized acquisition pool investment vehicle (e.g., to any investors who contributed funds to the trust). The voting rights are allocated based on the proportional amount of capital provided by each investor. In another embodiment of the invention, investors who provide a greater amount of capital receive a super-preferred voting right entitling any investor providing substantially more capital with an extra voting right. For example, for an issuer capitalized with $10,000,000 by 10 investors, one investor may provide $5,000,000 in capital and no other investor provides more than $1,000,000. The investor providing 50% or more of the capital may be entitled to a series of stock or a preferred security having a certain percentage of additional votes in excess of a 50% fraction of the total votes. In still a further embodiment of the invention, voting rights may be alienated from the preferred security or new preferred voting rights may be created for other parties such as a consultant or a placement agent or any party holding a future ownership interest in the collateralized acquisition pool investment vehicle. Alienated preferred voting rights may be traded to outside parties or accumulated by any of the investors.

As discussed above, the funds of the collateralized acquisition pool investment vehicle (e.g., those funds provided by the investors in exchange for the preferred and/or convertible security and held in a trust or controlled account), in one aspect of the invention, are used to capitalize the issuer. The investors, through a special (e.g., the preferred) voting right release the funds to the issuer under certain constraints and conditions. When the issuer is a stock corporation trading on a securities market the issuer does not have control or use of such funds until the funds are released and/or approved by the investors. The release of funds to the issuer normally does not provide funds for the general operating capital or expenses of the issuer, nor does the release of funds function to pay for the general operating expenses of the issuer. Instead, upon a vote by the investors to release the funds or any portion of the funds from the trust (e.g., controlled account) to the issuer, the funds thus released must be used for a specific purpose. The funds are used only for the purpose for which the investors have voted to release the funds.

For example, when a particular investment or asset is identified by the investors as an acceptable and desirable use of the investor's funds, and the investors vote to dedicate (e.g., release) the funds for the purchase of this asset, then the funds are released so that the issuer may acquire the asset. However, the funds may only be used for the purpose of purchasing the particular asset agreed upon by the investors through the special vote. Funds may be concurrently released to pay other expenses including any ancillary expense, such as the fees of the placement agent. The funds from the trust may pass through the issuer's infrastructure (e.g., accounts and/or accounts payable departments) and thus may utilize the administrative infrastructure provided by the issuer, but the issuer preferably does not burden the finds with a management fee for such services.

In another embodiment, the issuer receives a management fee for handling the funds. The management fee maybe a flat fee or may be a percentage of the funds handled by the issuer.

In one aspect of the invention, the identification of an asset that may be purchased, resold and/or otherwise handled in a manner that results in a desirable outcome for the investors (e.g., so that the investors are able to obtain a significant and positive return on the funds invested in the issuer), is an important part of achieving the investor's objectives and carrying out the purposes of the collateralized acquisition pool investment vehicle.

In order to identify assets that represent a profitable investment opportunity, the investors will rely upon the advice and services of a management team. Typically, the management team is in possession of an idea and/or a business plan before approaching a group of investors. However, in the absence of capital, the management team is unable to carry out the business plan or investment idea in a manner that most effectively utilizes the management team's resources and achieves the greatest return an invested capital. Further, in many cases the management team may not have the resources to dedicate full time attention to carrying out the business plan in the absence of receiving a periodic salary. Preferably, the management team is paid a salary and the management team's expenses are reimbursed by the investors from the funds provided by the investors before or after a vote by the investors and/or the investor's ownership interests.

In one embodiment, the salaries and/or general operating expenses necessary in order to identify an asset for investment purposes (e.g., a target asset) are obtained from the funds provided by the investors. For example, the expenses may be those expenses associated with the salaries and expenses of a management team and/or the expenses incurred by the management team in identifying a target asset. These funds may be obtained by release of a portion of the collateralized acquisition pool investment vehicle's funds (e.g., an issuer's controlled account). By releasing a portion of the funds, the issuer covers the management team's expenses such as salary, travel and administrative costs, associated with activities necessary to identify or prepare assets for purchase.

The portion of the funds released in order to obtain sufficient capital to cover the expenses associated with the management teams activities identifying assets for purchase may vary. For example, as much as 50% of the funds in trust may be released, preferably no more than 25%, more preferably no more than 10%, and even more preferably no more than 5%. There is no restriction on the amount of funds that may be released in order to cover the expenses associated with identifying an asset for purchase. Thus, any portion of the funds in trust may be released to pay the management team's expenses, including 0.5%, 0.75%, 0.1%, 1%, 2%, 3%, 4%, 5%, 10%, 15%, 20% and all ranges and subranges therebetween.

As was mentioned above, funds may be released to the issuer for carrying out a particular business plan and/or making an acquisition upon an affirmative vote by the investors or holders of the current ownership interests. Release of the funds to the issuer does not necessarily convert the investor's interest from a preferred security such as a note to a common stock interest. Instead, the ownership interest may remain in the form of a note providing the investor a secured interest with respect to any bankruptcy or default of the issuer.

In an alternate embodiment, an affirmative vote by the investors to release funds to the issuer may result in conversion of the convertible security from the form of a note into the form of stock which may be, for example, common stock, unregistered stock or a preferred stock. In this embodiment, conversion of the preferred security to a stock security provides the investor with a current ownership interest in the form of a stock ownership interest and a future ownership interest.

The funds may be released in different amounts at different times subject to voting by the investors. A vote of the investors to release funds to the issuer may result in conversion of the ownership interests to a converted ownership interest. The converted ownership interest may have both a current and future component. Subsequent conversions may provide the investors with further current and/or future ownership interests in different amounts and/or proportions. In one embodiment, an investor is provided one future ownership interest for each current ownership interest. The future ownership interest may be a warrant that entitles the investor to purchase a proportional unit (e.g., a proportional number of shares) of any investment made by the capitalized acquisition pool for a predetermined price. The predetermined price may be greater or lower than the face value of a single unit of the current ownership interest (e.g., the predetermined price may be greater than or less than the amount the investor paid for a single unit of the ownership interest). In a preferred embodiment, the future ownership interest provides the investor with an opportunity and/or a right to purchase a current ownership interest in a collateralized acquisition pool investment vehicle for an amount that is less than the amount the investor paid for the current ownership interest.

Conversion of the convertible security to an ownership interest such as a preferred security or the conversion of a future ownership interest to a current ownership interest may be conditioned with one or more temporal and/or performance conditions. For example, conversion of the future ownership interest may be limited by a requirement that conversion to a current ownership interest may only happen after the passage of a certain amount of time (e.g., two years). For example, the future ownership interest may be a warrant that may be exercised only after two years have passed after the investors voted to convert a portion of the funds in trust to an ownership interest. Any period of time may be specified as a temporal condition, such as 1, 2, 3, 4, 5 years or any fraction or multiple thereof in months, or quarters. The condition may apply solely to that portion of the total warrants associated with the released funds or alternatively the condition may apply to all warrants and/or all future ownership interests regardless whether they correspond with unreleased funds.

Alternatively, or in addition, conversion of the future ownership interest to a current ownership interest may be limited by one or more performance criteria regarding the financial performance of the collateralized acquisition pool investment vehicle or any asset held by the investment vehicle. For example, conversion of a future ownership interest to a current ownership interest may be restricted by a requirement that the current or future ownership interest have a minimum trading value or volume on a securities market and/or the assets purchased with the released funds must provide a certain minimum rate of return and/or certain milestones regarding the consolidation, merger, sale, etc., of any assets purchased with the funds must have been achieved.

When presented with an asset under consideration for purchase (e.g., a business combination proposal and/or a target asset for purchase), each party having a current ownership interest (e.g., holders of the preferred security having a preferred voting right) may vote whether to approve the purchase of the asset. Preferably, a majority vote is required to approve of a transaction. Preferably, more than 95%, more than 90% or more than 80%, or at least 75% of the investors must vote to accept the transaction. In other embodiments, a vote of more than 50%, preferably more than 49.5%, alternatively more than 33.3%, more preferably more than 30%, more preferably more than 20% preferably more than 10% of the preferred voting rights authorizes the purchase of a target asset (e.g., the release of the funds of the collateralized acquisition pool investment vehicle).

Upon an affirmative vote (e.g., approval by the investors), the funds are released to the issuer but may be used only for the purpose of carrying out the asset purchase etc. which the management team submitted and the investors approved. The contribution of any of the investor's funds to the purchase of the asset may be grossed-up, as necessary, to meet the purchase price of the transaction plus any commission payable to the placement agent or other fees necessary to complete a transaction. Grossing-up may also be required when some of the security holders (e.g., investors) decline to participate in an asset purchase. An investor declining to participate leads to a segregation of the investor's funds from the funds released to the issuer. Any shortfall in the amount needed to carry out the transaction is balanced with additional funds obtained from the investors willing to participate in the transaction. Depending on, for example, the number of affirmative votes (i.e., the number of participating investors) and the total number of investors, the final contribution amount of any particular investor may be greater than the contribution amount that would have occurred if the security holders unanimously approved the transaction (not including any placement agent fees, which will also be included). For example, in a case where there are a total of four investors and a vote of 75% is required in order to release funds to the issuer, if three of the investors approve of the release of funds and there is one investor who declines (e.g., casts a “no” vote), the contribution of each of the three investors voting to approve the transaction must be increased by 33% relative to the amount they would have contributed if all four investors had agreed to undertake the transaction. Of course the amount of contribution increase will vary depending on, for example, the total number of investors and the threshold investor approval required to carry out a transaction.

For each investor or holder of a preferred security having a preferred voting right that votes to approve a transaction, a pro rata portion of the purchase price will be released out of the funds in trust on a date that may be set by agreement or set by default after a transaction is approved. A threshold acquisition date may be defined for any conversion and/or transaction. This may be required under U.S. securities laws so that any underlying shares (e.g., an ownership interest represented by common, preferred or unregistered stock) may be registered. The securities regulations of foreign countries do not, in all cases, require a threshold acquisition date and/or do not require registration of ownership interests in the form of stock. Thus, if a transaction is carried out in a foreign country (e.g., carried out subject to a foreign country's security regulations), a threshold acquisition date may not be necessary.

For example, the threshold acquisition date and/or the maturity date of a convertible security may define the date whereupon the principal amount of the convertible security is redeemable. Any amount that is not released due to the failure of the threshold acquisition date to occur or otherwise, may be deemed outstanding principal, due and payable in cash at the maturity date or such other date where upon the principal amount is due and payable.

After a purchase transaction has been completed, each investor and/or each holder of preferred security having a preferred voting right that voted against the transaction may have a pro rata portion of the purchase price that would have been used in the transaction redeemed at par using their portion of the funds in the trust or controlled account. Notwithstanding the foregoing, the pro rata portion of the purchase price attributable to a security holder and/or investor voting in favor of a purchase transaction may not exceed the amount of funds attributable to the finds provided by that investor (e.g., the proportional amount initially invested by the investor).

As was mentioned above, the collateralized acquisition pool investment vehicle functions in one aspect in order to identify assets for investment by investors and ultimately for the purchase of such investments (e.g., business assets) by an issuer. The investors preferably do not actively participate in the search for assets that may be purchased. Instead, a management team undertakes this responsibility. The management team may receive compensation in the form of salaries paid by the release of the funds after conversion whereby the investors received a first current ownership interest and a first future ownership interest.

In an especially preferred embodiment, the investors sell a first future ownership interest to the management team. The sale of the first future ownership interest to the management team may fulfill two important functions. (1) The sale of the future ownership interest provides an immediate return to the investors so that at least a portion of the fund pool which was released in order to pay for the operating expenses of the collateralized acquisition pool investment vehicle is returned to the investors. Thus, any initial loss of cash value surrendered by the investors to fund the initiation of the investment vehicle and/or engagement of the management team is balanced by income received from the management team's purchase of the investor's first future ownership interest. (2) The purchase of the future ownership interest also provides a means of entitling the management team to an ownership interest in any venture or investment carried out with the investor's funds.

Because the ownership interest purchased by the management team (e.g., exercise of the first future ownership interest purchased from the investors) may come with performance-based restrictions (e.g., the future ownership interests may be conditioned on performance milestones and/or targets), the performance of the investment may be directly tied to any future financial reward received by the management team. Moreover, the management team's investment in the collateralized acquisition pool investment vehicle serves to show the management team's commitment to any asset purchase funded by the investors.

Before purchasing any future ownership interest, the management team must first be engaged. The management team may initially be identified by the placement agent, or the management team may be identified by one or more investors participating in the collateralized acquisition pool investment vehicle. The management team may seek investors independently from any placement agent. Typically, a management team is engaged contractually for a limited period of time within which the management team must come forward with a proposal for the purchase of a specific asset. In contrast to a special purpose acquisition company (e.g., SPAC), the management team in the method of the invention and in a collateralized acquisition pool investment vehicle, may have a preconceived notion of an investment before contacting the placement agent. The management team may represent and/or include one or more managers from an existing, ongoing business asset. The managers may identify the existing, ongoing business asset as the target asset for purchase by a group of investors using a collateralized acquisition pool investment vehicle.

A management team may be engaged in different ways. For example, the management team may be identified and recruited by a placement agent. When the management team is recruited by the placement agent, the placement agent may be responsible for identifying a particular investment opportunity such as one or more businesses which may be acquired and/or subject to merger and acquisition activities. The placement agent may recruit the management team by advertising for particular individuals having certain skills.

In another embodiment, the management team is engaged by a referral from another source such as a consultant or any individual having knowledge of a particular industry and wishing to capitalize upon a particular opportunity wherein a collateralized acquisition pool investment vehicle may be used. For example, a referral may come from an investment group having particular knowledge of a specialized industry but lacking the infrastructure and knowledge with which to set up a collateralized acquisition pool investment vehicle. In a preferred embodiment, a party referring a management team to a placement agent or to the collateralized acquisition pool receives a future ownership interest in consideration for the referral. The future ownership interest may be a warrant that is exercisable upon completion of a business asset purchase.

In an especially preferred embodiment, the management team seeks out a placement agent or party involved in organizing investment vehicles. The management team in this embodiment may be made up of one or more managers presently employed in a particular industry and having intimate knowledge of the industry. The management team thus engaged may select the current company with which they are employed as an opportunity for investment by the collateralized acquisition pool. In an embodiment where the management team seeks out the investors in order to form a collateralized acquisition pool or in order to carry out particular merger and/or acquisition activities relating to a particular industry and/or business opportunity, the placement agent and/or investors of the collateralized acquisition pool have increased negotiating power with the management team. Because there may be many opportunities for using collateralized acquisition pool investment vehicles in different industries, it is preferable that the management team seek out the investors of a collateralized acquisition pool to keep the costs for engaging a management team low relative to the expenses of the collateralized acquisition pool investment vehicles.

There is no restriction on the number of executive managers or mid-level managers which may be a part of the management team. Preferably the management team consists of a core group of up to five senior level managers having a defined future ownership interest in the collateralized acquisition pool investment vehicle. Preferably, the management team is made up of experienced managers in a particular industry or technology.

The management team may obtain a future ownership interest as mentioned above (e.g., by purchasing a future ownership interest from the investors). Alternatively, or in addition, the management team may be given a right or entitlement to a further ownership interest based upon performance. Performance may be based upon the completion of a successful asset purchase, a profitable sale of a previously purchased asset, or any other financial goal or incentive.

For example, any of one or more of the management team, the placement agent and/or any parties approved by the investors may agree to purchase series B warrants (as defined below) issued by the issuer and equal to a certain percentage of the series A warrants issued to the investors. The series B warrants are purchased for a certain amount and at least a portion of the proceeds may be included in the controlled account for the benefit of the investors. The series B warrants may be the same as the series A warrants, but may exist without forced exercise provisions.

Investors may also receive an additional (e.g., second) future ownership interest. The second future interest (e.g., series B warrant) may be the same as the first future interest and may be a marketable security. The investors may immediately sell the second future interest to the management team or any other party through, for example, a publicly traded securities market. The second future interest may have conditions that are the same as or different from the first future interest. Thus the second future interest may have a temporal or performance-based condition that is the same or different from the conditions of the first ownership interest.

Once a management team has been engaged, the management team assumes control of the issuer that is used as part of the collateralized acquisition pool investment vehicle. The issuer is preferably in the form of a shell corporation that is under the full control of the management team. One way for the management team to assume control of the issuer is for the management team to carry out a merger of a first company with the issuer. Preferably, such mergers take place as stock transactions. The management team may control a private or public company that is merged with or acquires the issuer.

In a preferred embodiment the management team controls a private company. The management team then acquires the issuer or a subsidiary of the issuer and thereby obtains control of the issuer. Thus the initially private company controlled by the management team becomes a public company when a majority of the voting stock of the issuer is purchased or otherwise comes under the control of the management team.

It is possible for the management team to already have control of an issuer or a publicly traded stock company. The management team may include individuals currently employed by a company that is the target of the collateralized acquisition pool investment vehicle and which may be a publicly traded company. In this case, the management team may already control a majority of the voting stock of the publicly traded company and the publicly traded company controlled by the management team may be used as the issuer without requiring the acquisition of a shell corporation. In such a case, if the management team does not already own a controlling voting share of the stock of the publicly traded company with whom they are employed, the management team may purchase a further amount of voting shares of the publicly traded company in order to obtain a full majority of the voting stock of the publicly traded company.

After engagement, the management team may identify one or more assets for purchase. The management team may then submit a proposal to the holders of the current ownership interests (e.g., those investors having a preferred voting right in the issuer). The current ownership interests (e.g., holders of the preferred security having a preferred voting right) may then exercise their preferred vote to determine whether to release funds so that a purchase of the asset identified by the management team may be undertaken. The proposal is submitted to all current ownership interests and any preferred voting right that may be alienated (e.g., sold or separated) from a current and/or future ownership interest. The management team may propose different assets for purchase individually, as a group or both individually and as a group. If the management team provides a proposal on a group of assets for purchase the current ownership interests may vote individually upon each proposed asset for purchase in the group or may vote collectively whether to accept all of the proposed assets for purchase in the group.

Once presented with the management team's proposal for asset purchases, the current ownership interests (e.g., the investors providing funds and having a current ownership interest and a preferred voting right) decide whether to release funds to the issuer in order to carry out a purchase. The requirements (e.g., minimum vote) necessary in order to be eligible for releasing funds to the issuer may vary. If the current ownership interests are voting to determine if a single proposed asset for purchase is acceptable, in one embodiment, a simple majority is sufficient to accept the management team's proposal and initiate the purchase. In another embodiment a super majority (i.e., ⅔ of all preferred voting rights accepting the proposal) may be required. A quorum may be required to initiate a vote (e.g., at least 50% of all voting rights must be voted in order for a vote to cause a release of funds to the issuer).

When the current ownership interest undertakes a vote to determine whether to release funds to purchase a target asset or a group of proposed assets, in one embodiment, the proposal that is accepted is the one having the greatest share of votes relative to all votes cast. In other embodiments when a group of proposed assets for purchase is considered by the current ownership interest, more than one asset for purchase may be accepted, for example the first two, the first three, or the first four proposals having the greatest proportion of preferred voting relative to the total number of preferred votes cast, may be accepted for a release of funds to the issuer.

After an asset purchase proposal has been accepted by the current ownership interests (e.g., investors holding a preferred security having a preferred voting right), the finds necessary to complete the purchase of the asset are released from the funds in trust or the controlled account. As mentioned above, the release of the funds does not necessarily result in conversion of the investor's convertible security to a stock ownership interest. Instead, conversion includes embodiments where the funds are released to the issuer; however, the ownership interest of the investor remains in the form of, e.g., a secured note. It is not necessary that all of the funds in trust are released to the issuer. Preferably only an amount of funds is released that corresponds with the amount of funds necessary to complete the purchase of the proposed asset (i.e., the asset or assets identified by the management team).

After successfully identifying and acquiring an asset, the management team may be compensated with a grant of stock in the issuer. The management team may be awarded as much as 50% of the common stock of the issuer, preferably as much as 25%, more preferably as much as 10% and even more preferably no more than 5%. The management team may be awarded any amount of the common stock of the issuer including any multiple or fraction of the aforestated amounts including any ranges or sub-ranges defined by any fraction or whole integer value percent of the total common stock. The award may be contingent upon a later sale of the asset or predetermined performance criteria.

In one embodiment of the invention, the asset or the group of assets identified by the management team is of greater value than the funds provided by the investors (e.g., the funds available in the trust or the controlled account). In order to complete a purchase of the asset, the collateralized acquisition pool investment vehicle may leverage the purchase of the asset through borrowed funds. Borrowed funds may come from any source including additional funds provided by the investors as a group or individually, or from any lending institution or lending party. There is no preset condition on the maximum amount of borrowed funds that may be used.

After all funds in the trust of funds are used or the management team has completed identifying assets for purchase, any funds remaining in the trust of funds may be returned to the investors on a pro rata basis according to each investor's remaining unreleased share.

The organizing of a collateralized acquisition pool investment vehicle including identifying investors, organizing the structure of the collateralized acquisition pool, and carrying out the administrative and organizational duties necessary in order to form the acquisition pool, require significant resources. These duties may be performed by a placement agent. The placement agent may be compensated for services on a contractual basis by the management team and/or the issuer. Initially, the management team may form an agreement or a contract with a placement agent before executing of any agreement towards carrying out a transaction. After the management team has assumed control of the issuer, compensation for the placement agent becomes a contractual obligation of the issuer. In other embodiments the placement agent may be paid by other parties involved in the transaction including the investors, the target of any transaction, and/or through the administrative fees charged by an investment fund utilizing the services of the placement agent.

For example, in payment for services the placement agent may obtain a fee from the investors. The fee may correspond to a portion of the amount of funds invested by the investors. The portion of the funds may be spread equally among all investors on a pro-rata basis according to the amount of funds provided by each investor, or the placement fee may be a flat fee which is paid by each investor separately, or a combination thereof. Typically, the placement agent receives a fee after the investors release funds to the issuer. In alternative embodiments, the placement agent may receive a current or future ownership interest that becomes possessory or entitled only after certain goals or milestones are met by the collateralized acquisition pool investment vehicle or the management team. In a preferred embodiment the placement agent is paid a percentage of the placement agent's fees after the management team has assumed control of the issuer. Further payments are made to the placement agent upon each successful transaction. The placement agent's fees may be dependent upon and/or may represent a fraction of the amount of funds released to the issuer and/or the amount of finds expended for carrying out any particular transaction. Other embodiments include deferment of the placement agent's fees until all of the funds have been released to the issuer or have been disbursed in transactions.

### EXAMPLE

The method of the invention and a collateralized acquisition pool investment vehicle are demonstrated by the following example which is not intended to limit the invention described and claimed herein.

Table 1 provides an overview of an investment process undertaken to acquire a plurality of assets, e.g., a process utilizing a collateralized acquisition pool investment vehicle. Each of investor's A, B, C, and D provides an amount of funds of a total value of $1 million. The net amount of funds available after fees and a reduction in expenses, for example a 1.5% placement fee paid to the placement agent is $985,000 for each of investor's A, B, C and D.

TABLE 1

| | Investor | | | |
|---|---|---|---|---|
| | A | B | C | D |
| Initial Principal Amount of | $1 million | $1 million | $1 million | $1 million |
| Note | | | | |
| Available Amount Remaining | $985,000 | $985,000 | $985,000 | $985,000 |
| for Future Acquisitions (after | | | | |
| fees and expenses reduction) | | | | |
| Acquisition 1 Purchase Price | Yes | Yes | Yes | No |
| of $1 million | $333,333 (1) | $333,333 (1) | $333,333 (1) | Redeemed |
| | to Purchase | to Purchase | to Purchase | $250,000 |
| | Price | Price | Price | |
| Available Amount Remaining | $651,667 | $651,667 | $651,667 | $735,000 |
| for Future Acquisitions | | | | |
| Acquisition 2 Purchase Price | Yes | No | Yes | No |
| of $1 million | Transaction | Transaction | Transaction | Transaction |
| | Does not | Does not | Does not | Does not |
| | Close | Close | Close | Close |
| Available Amount Remaining | $651,667 | $651,667 | $651,667 | $735,000 |
| for Future Acquisitions | | | | |
| Acquisition 3 Purchase Price | Yes | No | Yes | Yes |
| of $2.0 million | $651,667 (2) | Redeemed | $651,667 (2) | $696,666 (3) |
| | to Purchase | $500,000 | to Purchase | to Purchase |
| | Price | | Price | Price |
| Available Amount Remaining | $0 | $151,667 | $0 | $38,334 |
| for Future Acquisitions | | | | |

(1) Purchase Price of $250,000 grossed-up to $333,333.
(2) Purchase Price of $500,000 grossed-up to $651,667 (the remaining Available Amount).
(3) Purchase Price of $500,000 grossed-up to $696,666.

The investors are presented with a first asset (e.g., business asset investment) having a price of $1,000,000. At this point, because no purchases have yet been undertaken there is a sufficient amount of funds available in the total amount of funds (i.e., 4×$985,000=$3,940,000). Three of the investors agree to undertake the first purchase (i.e., investors A, B and C each vote to approve the first purchase). One of the investors (i.e., investor D) declines to participate in the investment and votes against the purchase. In order to collect the $1,000,000 purchase price of the first acquisition, each of investors A, B and C must contribute $333,333. Thus, an initial contribution of $250,000 must be grossed-up to $333,333. It should be noted that because three of the four investors voted to approve the first acquisition, the acquisition is approved and the necessary funds are released from the issuer in order to pay for the first acquisition.

Investor D, who voted against carrying out the first acquisition, is redeemed the amount of funds equivalent to the amount investor D would have had to contribute to the first acquisition if there had been unanimous consent amongst all investors to carry out the first acquisition (i.e., $250,000).

A second acquisition having a purchase price of $1,000,000 is then proposed to the investors. Two of the investors (i.e., investors A and C) vote to approve the purchase whereas two other investors (i.e., B and D) vote against the purchase. Because in this case a majority vote was not obtained the transaction does not close and no funds are released or redeemed. No investor receives a redeemed contribution because the transaction did not close and no investor contribution is grossed up.

A third acquisition is then presented to the investors for approval. Three of the investors (i.e., A, C and D) vote to carry out the acquisition. Two of the investors (investors A and C) have an amount of funds available for investment of only $651,667. However, because one of the investors (investor B) refused to participate, the entire purchase price of the third acquisition must be spread amongst the three investors voting to carry out the acquisition. It is not possible to gross-up the amounts contributed by investors A and C because no further funds are available from these investors. However, investor D has sufficient funds available in order to make up any deficit with respect to the amount of funds available from investors A and C. Investor D has extra funds available because investor D did not participate in the first acquisition. Thus the contribution of $651,667 from investors A and C and an amount of $696,666 from investor D is sufficient to cover an acquisition cost of $2,000,000 and the transaction closes. Investor B, who did not participate and whose pro rata share of the $2,000,000 investment cost for the third acquisition would have been $500,000 if all of the investors had agreed to participate, is redeemed $500,000. At the end of these transactions, an amount of funds is still available for future acquisitions from investors B and D.

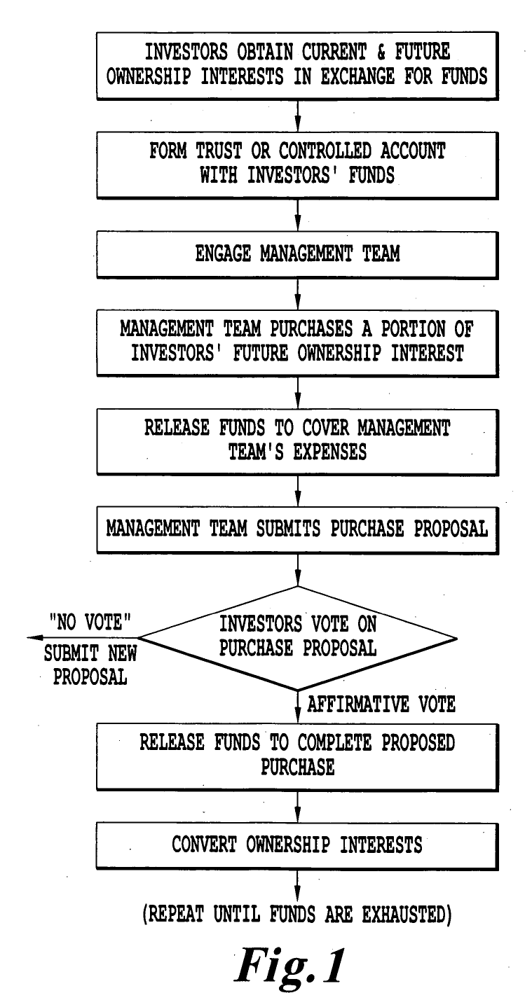

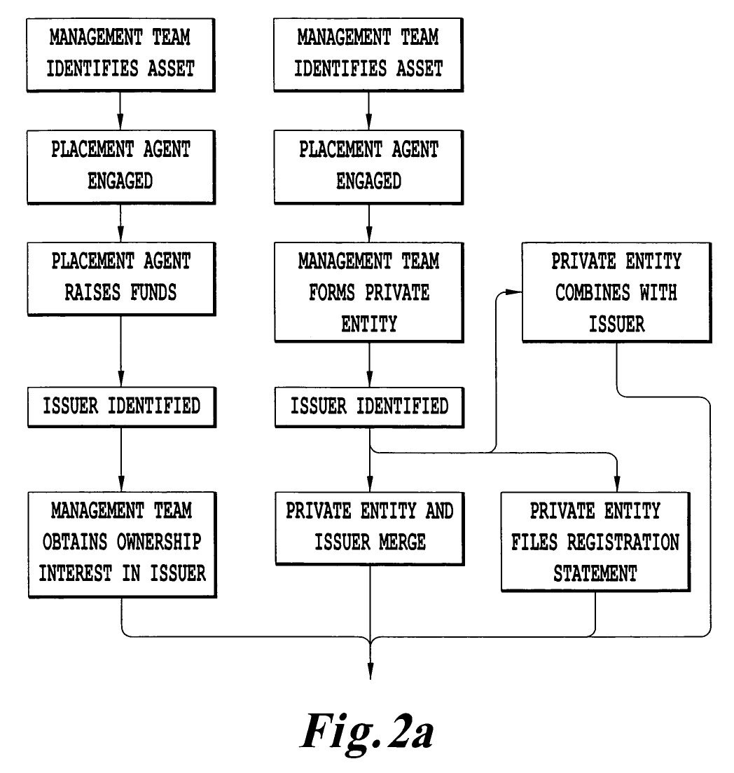

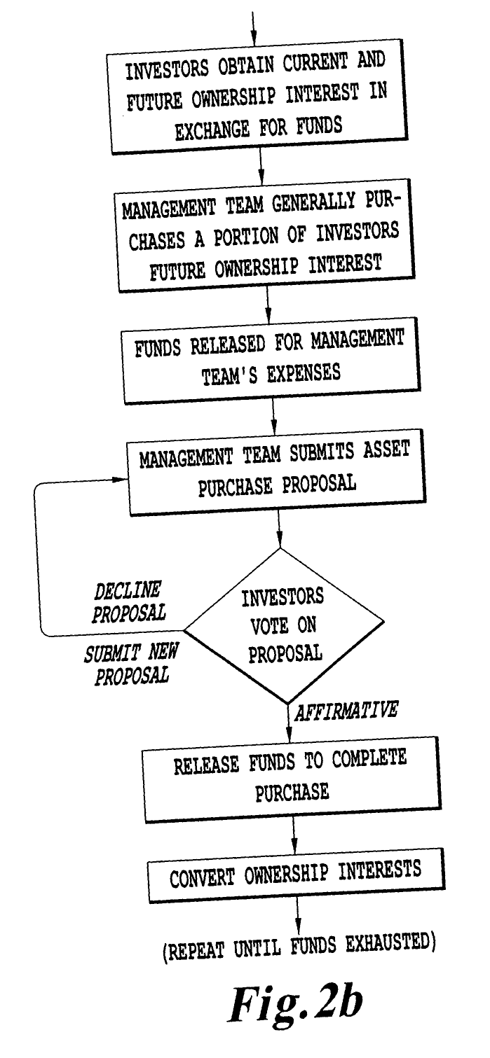

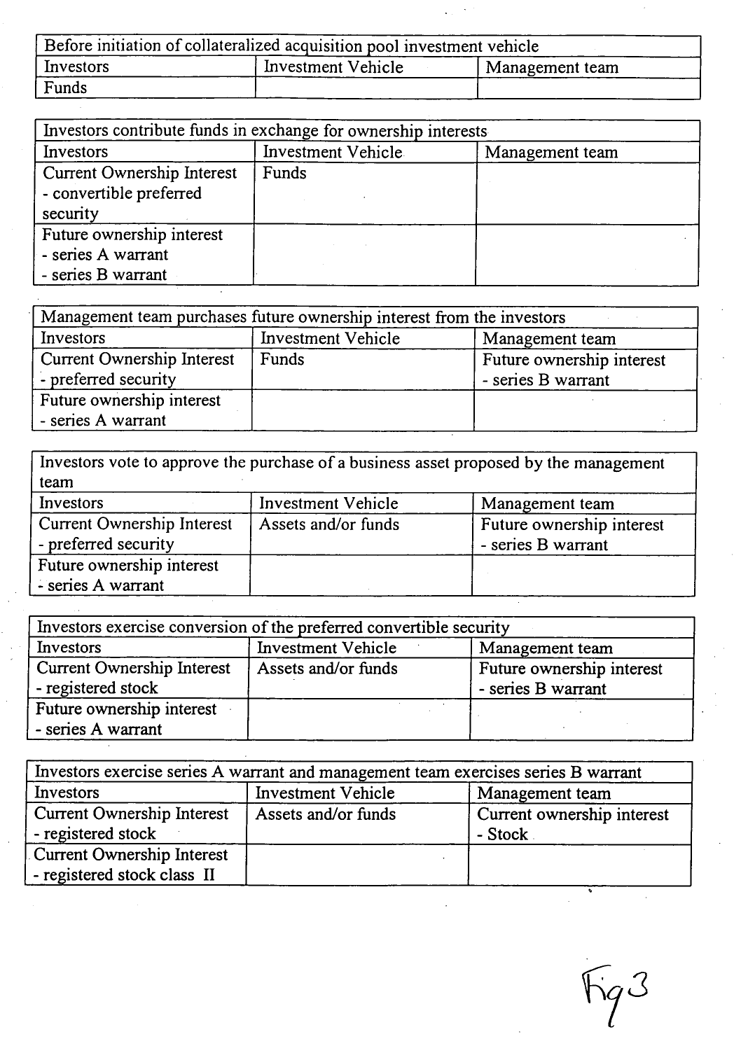

Applications of the invention method may include or be encompassed by the high-level diagram of FIGS. 1 and 2. FIG. 3 shows a high level view of the flow and change in ownership interests and funds that may occur in one embodiment of the invention. FIGS. 1 and 2 do not limit the invention but instead serve to illustrate different embodiments. Other embodiments may include a portion of the same steps shown in FIGS. 1 and 2, all of the steps shown in FIGS. 1 and 2, additional steps not shown in FIGS. 1 and 2, in the same sequence or in a different sequence. In FIG. 1, initially an amount of funds may be sought from investors. The investors may be approached directly by a placement agent offering the collateralized acquisition pool acquisition investment vehicle directly to the investors or through another placement agent or investment advisor. The investors may make commitments to dedicate certain amounts of funds or a guarantee of funds to the collateralized acquisition pool investment vehicle. The collateralized acquisition pool investment vehicle may be initiated with a target capitalization value. A sufficient number of investors are approached to obtain an amount of capital to reach the target capital value. After commitments for a certain amount of capital are received from one or more investors, an acquisition pool is formed by transfer of the funds from the investors to the placement agent or other agent organizing and/or maintaining the collateralized acquisition pool acquisition investment vehicle. The funds thus obtained are held by a trustee in a trust or by the issuer in a controlled account. Once the acquisition pool is formed and the funds are present, the funds may be invested to pay a periodic payment or dividend. Thus, the acquisition pool may have the characteristics of a note having a certain underlying value and paying a certain coupon.

The funds of the acquisition pool are then converted in order to provide the investors with an ownership interest. After conversion, the investors may have, e.g., a convertible security, another security, a stock, or a combination thereof, and the issuer may have the funds or a portion of the funds. Conversion corresponds to a release of funds to the issuer. Release of funds provides the capital necessary for the collateralized acquisition pool investment vehicle to undertake its actions as an investment vehicle. Conversion is not necessarily carried out by providing the investors with a ownership interest in the form of stock but may instead provide the investors with an ownership interest in the form of any security, including a note and a preferred security (optionally in addition to a stock), any of which may be further convertible to provide the investors with an ownership interest in the form of stock.

An amount of converted funds may be used to cover the expenses that may be associated with the salaries of a management team and other expenses needed in order to identify target assets for acquisition. Upon conversion, the investors providing the funds of the acquisition pool receive a current ownership interest and a future ownership interest. The current ownership interest may be a preferred security having a preferred voting right in an issuer. The future ownership interest may be a warrant providing the right to purchase a certain amount of shares or securities in the issuer at a preset price.

The management team may immediately purchase a portion of the future ownership interests received by the investors before or after conversion of the first portion of the acquisition pool to provide operating funds for the collateralized acquisition pool. The management team is engaged by forming a management team agreement defining the conditions under which the management team may participate in the collateralized acquisition pool investment vehicle and/or conditions under which the management team receives a salary or payment for services.

The management team proposes one or more target assets for purchase. The management team generally knows of a target asset for purchase within an industry in which the management team formerly or currently has management or other relevant business experience. After identifying a suitable target asset for purchase, the management team forwards a proposal to the investors for approval of the purchase of the asset. The investors then vote to determine if purchase of the assets is in the best interest of the collateralized acquisition pool acquisition investment vehicle. If the investors do not vote to accept the purchase of the assets, the management team may identify one or more further target assets for purchase.

If funds remain available in the issuer account, the management team may propose further target assets and may forward further proposals for purchase to the collateralized acquisition pool acquisition investment vehicle.

The invention may be carried out in different embodiments whereby the funds are raised by different parties or by different participants such as those in the high level diagram of FIG. 2. For example, a collateralized asset pool may be initiated or started by a management team. The management team may seek out and engage a placement agent. By engaging the placement agent, the management team may rely upon the placement agent to raise the funds necessary to form the collateralized asset pool. Either the placement agent or the management team may identify a public company that the management team or placement agent may later control. Alternatively, the placement agent may already be in control of a public company that may form a part of the collateralized asset pool. It is preferred in this embodiment of the invention that the placement agent raise the funds from investors. Even more preferably, all of the funds necessary to fund the collateralized asset pool are raised from investors by the placement agent. The public company may function only to provide the legal requirements necessary to be deemed a public company (i.e., a shell company without ongoing business interest) and/or the public company may be an operating company with ongoing business interests. The management team may become an owner of the public company during the financing of the collateralized asset pool.

In another embodiment that includes engaging a placement agent with the management team, the management team forms a private entity that may be, for example, an S corporation, a limited liability corporation, or another entity that is not a public company and that may be owned by a plurality of individuals or parties. Either or both of the placement agent or the management team may identify a public company that may play a role in the collateralized asset pool (e.g., the public company may be the issuer). The placement agent raises funds from one or more investors to thereby form a fund pool. In this embodiment the private entity formed by and owned by the management team may combine with the public company. The combination of the private entity and the public company may include, e.g., a merger of the private entity and the public company, and an acquisition wherein either the private entity acquires the public company or the public company acquires the private entity. In this embodiment, the public company (e.g., the issuer) may be any company meeting the legal requirements of a public corporation and/or a company with an ongoing business interest (e.g., an operating company).

In another embodiment wherein the management team engages the placement agent, the management team also forms a private entity and the placement agent raises the funds for the collateralized asset pool, the private entity owned by the management team may become a public company by filing a registration statement with the Securities and Exchange Commission. By changing the private entity to a public company, this embodiment of the invention may proceed without the identification and purchase (e.g., control) of a separate public company (e.g., issuer) that is not related with the private entity (e.g., the private entity is converted to carry out the function of the issuer). However, this embodiment of the invention also includes embodiments where the private entity is merged and/or acquired by, or acquires a second public company after conversion to a public company. The public company may have been previously identified and/or formed by the management team or the placement agent.

In another embodiment, the placement agent may be engaged by a private entity having a management team. The private entity may also engage the placement agent to raise the funds necessary to carry out or form a collateralized asset pool. The public company (e.g., a shell company or an operating company carrying out the function of the issuer) may be identified by either or both of the placement agent and the management team. The placement agent raises the funds necessary to initiate or carry out the collateralized asset pool from a plurality of investors. During the CAP, the private entity merges with, acquires or is acquired by the public company.

In another embodiment wherein a private entity having a management team engages a placement agent, the private entity may file a registration statement with the Securities and Exchange Commission to become a public company. Preferably, the registration statement is filed after the placement agent has raised the funds from a plurality of investors. The collateralized asset pool may further use only the converted private entity (the now public company) or a further public company (e.g., either a shell company or an operating company) may take part in the structuring of the collateralized asset pool.

In a manner similar to that described above wherein a private entity engages a placement agent, an existing public company (e.g., an issuer) may also engage a placement agent to raise the funds necessary to form or initiate a collateralized asset pool. In such an embodiment, the placement agent raises the funds necessary to form and/or fund the collateralized asset pool from a plurality of investors. The public company may be the only company in the collateralized asset pool or, alternatively, the public company may be merged with, acquire or be acquired by a second public company.

As is mentioned herein, the placement agent may carry out several rolls and/or functions within a collateralized asset pool. The placement agent may be engaged by, e.g., a private entity or a management team. Of course, the placement agent may also be engaged by the investors providing the funds for the fund pool of the collateralized asset pool. The placement agent may then seek out a management team or the management team may seek out and engage the placement agent.

It is not necessary for a placement agent to be a part of a collateralized asset pool or to be engaged as a part of using a collateralized asset pool. The investors may engage the management team or an issuer (e.g., a public company or a private entity) or the placement agent may engage the management team or an issuer. In such embodiments, communication and contact between the investors and the management team and/or the issuer is carried out directly without the need for a placement agent.

It is possible for an investor to already have an ownership interest in any one of the issuer, a public company and/or a private entity which becomes a part of the collateralized asset pool. If the investor has a significant ownership interest in the issuer and/or the public company, it is possible for the investor to participate in the collateralized asset pool without further contributing additional funds. In this embodiment of the invention, the investor's ownership interest in the private entity or the public company (e.g., the issuer) that is used as part of the collateralized asset pool acts as that investor's contribution of funds necessary to carry out the collateralized asset pool and/or form the fund pool.

The source of the management team is flexible. In one embodiment, the investors identify and bring forth a management team. The management team may otherwise carry out and have the characteristics of any of the management teams described above. For example, the investors may own a portion of a public company having a management team. The investors may identify the management team as capable of carrying out the functions of the management team of a collateralized asset pool. Thus the investors may contribute an equity stake in a public company as part of a contribution of funds and, in addition, the investors will concurrently provide a management team capable of carrying out a collateralized asset pool.

System for Purchasing Business Assets

The invention also includes a system for carrying out the purchase of one or more business assets. The system may include the collateralized acquisition pool investment vehicle described above and/or any component thereof described above. In the system of the invention, one or more of the steps of the method or functions of the collateralized acquisition pool investment vehicle described above may be carried out in an automated or computer-implemented fashion. For example, the capitalizing step of the method may be carried out by saving a record of the amount of funds provided by each investor onto a computer-readable format. By maintaining a record of each investor's amount of funds, and which investment each investor participated in, it is possible to obtain updates and records of the collateralized acquisition investment pool vehicle to determine whether sufficient funds are available to carry out any particular asset purchase. Likewise, other steps of the method wherein data is obtained, may be carried out by transcribing the data on a computer-readable format and carrying out numeric calculations and the like by computer thus simplifying and automating certain and/or all steps of the method of the invention.

The system of the invention combines the method described above with a collateralized acquisition pool investment vehicle product described above as a means for carrying out the acquisition of business assets in a manner that does not restrict the number of assets that may be purchased through an acquisition pool representing an amount of funds provided by a group of investors. The system of the invention further provides a way for investors to convert a private investment into an investment of a favorably controlled public entity to thereby create an investment which may mature to a registered security.

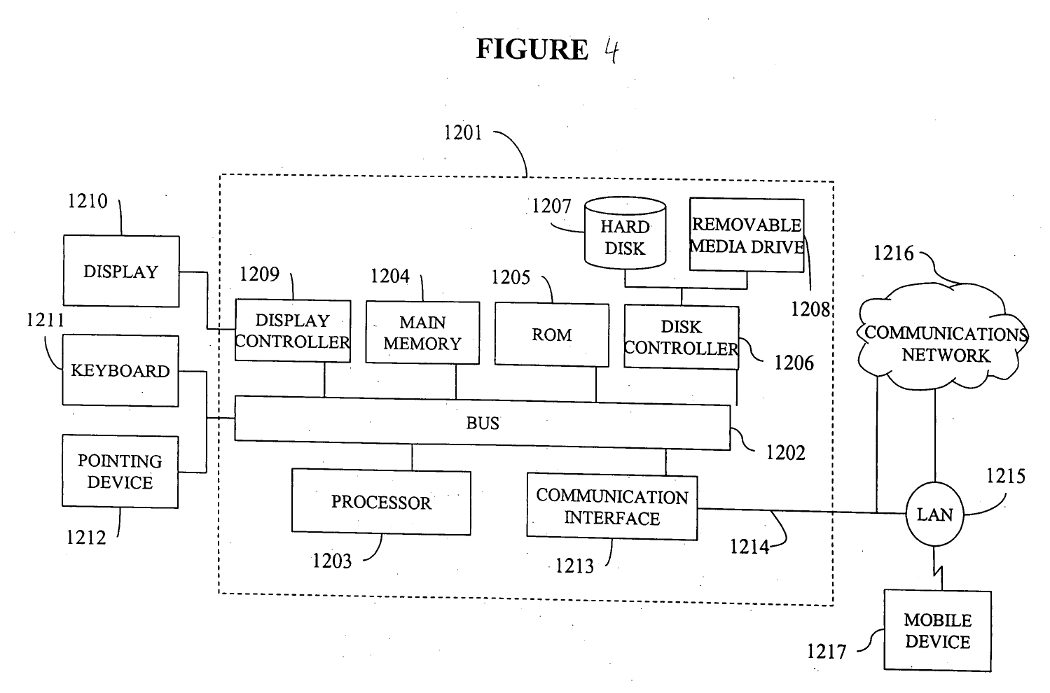

The system and/or method of the invention may be carried out on a computer system such as that of FIG. 4. FIG. 4 illustrates a computer system 1201 upon which an embodiment of the present invention may be implemented. The computer system 1201 includes a bus 1202 or other communication mechanism for communicating information, and a processor 1203 coupled with the bus 1202 for processing the information. The computer system 1201 also includes a main memory 1204, such as a random access memory (RAM) or other dynamic storage device (e.g., dynamic RAM (DRAM), static RAM (SRAM), and synchronous DRAM (SDRAM)), coupled to the bus 1202 for storing information and instructions to be executed by processor 1203. In addition, the main memory 1204 may be used for storing temporary variables or other intermediate information during the execution of instructions by the processor 1203. The computer system 1201 further includes a read only memory (ROM) 1205 or other static storage device (e.g., programmable ROM (PROM), erasable PROM (EPROM), and electrically erasable PROM (EEPROM)) coupled to the bus 1202 for storing static information and instructions for the processor 1203.

The computer system 1201 also includes a disk controller 1206 coupled to the bus 1202 to control one or more storage devices for storing information and instructions, such as a magnetic hard disk 1207, and a removable media drive 1208 (e.g., floppy disk drive, read-only compact disc drive, read/write compact disc drive, compact disc jukebox, tape drive, and removable magneto-optical drive). The storage devices may be added to the computer system 1201 using an appropriate device interface (e.g., small computer system interface (SCSI), integrated device electronics (IDE), enhanced-IDE (E-IDE), direct memory access (DMA), or ultra-DMA).

The computer system 1201 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1201 may also include a display controller 1209 coupled to the bus 1202 to control a display 1210, such as a cathode ray tube (CRT), for displaying information to a computer user. The computer system includes input devices, such as a keyboard 1211 and a pointing device 1212, for interacting with a computer user and providing information to the processor 1203. The pointing device 1212, for example, may be a mouse, a trackball, or a pointing stick for communicating direction information and command selections to the processor 1203 and for controlling cursor movement on the display 1210. In addition, a printer may provide printed listings of data stored and/or generated by the computer system 1201.

The computer system 1201 performs a portion or all of the processing steps of the invention in response to the processor 1203 executing one or more sequences of one or more instructions contained in a memory, such as the main memory 1204. Such instructions may be read into the main memory 1204 from another computer readable medium, such as a hard disk 1207 or a removable media drive 1208. One or more processors in a multi-processing arrangement may also be employed to execute the sequences of instructions contained in main memory 1204. In alternative embodiments, hard-wired circuitry may be used in place of or in combination with software instructions. Thus, embodiments are not limited to any specific combination of hardware circuitry and software.

As stated above, the computer system 1201 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 1201, for driving a device or devices for implementing the invention, and for enabling the computer system 1201 to interact with a human user (e.g., print production personnel). Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 1203 for execution. A computer readable medium may take many forms, including but not limited to, non-volatile media, volatile media, and transmission media. Non-volatile media includes, for example, optical, magnetic disks, and magneto-optical disks, such as the hard disk 1207 or the removable media drive 1208. Volatile media includes dynamic memory, such as the main memory 1204. Transmission media includes coaxial cables, copper wire and fiber optics, including the wires that make up the bus 1202. Transmission media also may also take the form of acoustic or light waves, such as those generated during radio wave and infrared data communications.

Various forms of computer readable media may be involved in carrying out one or more sequences of one or more instructions to processor 1203 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 1201 may receive the data on the telephone line and use an infrared transmitter to convert the data to an infrared signal. An infrared detector coupled to the bus 1202 can receive the data carried in the infrared signal and place the data on the bus 1202. The bus 1202 carries the data to the main memory 1204, from which the processor 1203 retrieves and executes the instructions. The instructions received by the main memory 1204 may optionally be stored on storage device 1207 or 1208 either before or after execution by processor 1203.

The computer system 1201 also includes a communication interface 1213 coupled to the bus 1202. The communication interface 1213 provides a two-way data communication coupling to a network link 1214 that is connected to, for example, a local area network (LAN) 1215, or to another communications network 1216 such as the Internet. For example, the communication interface 1213 may be a network interface card to attach to any packet switched LAN. As another example, the communication interface 1213 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1213 sends and receives electrical, electromagnetic or optical signals that carry digital data streams representing various types of information.

The network link 1214 typically provides data communication through one or more networks to other data devices. For example, the network link 1214 may provide a connection to another computer through a local network 1215 (e.g., a LAN) or through equipment operated by a service provider, which provides communication services through a communications network 1216. The local network 1214 and the communications network 1216 use, for example, electrical, electromagnetic, or optical signals that carry digital data streams, and the associated physical layer (e.g., CAT 5 cable, coaxial cable, optical fiber, etc). The signals through the various networks and the signals on the network link 1214 and through the communication interface 1213, which carry the digital data to and from the computer system 1201 maybe implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1201 can transmit and receive data, including program code, through the network(s) 1215 and 1216, the network link 1214 and the communication interface 1213. Moreover, the network link 1214 may provide a connection through a LAN 1215 to a mobile device 1217 such as a personal digital assistant (PDA) laptop computer, or cellular telephone.

Obviously, numerous modifications and variations of the present invention are possible in light of the above teachings. It is therefore to be understood that within the scope of the appended claims, the invention may be practiced otherwise than as specifically described herein.

1. A method for acquiring one or more assets with a collateralized acquisition pool investment vehicle, comprising:
obtaining a first amount of funds from one or more investors to form a fund pool;
forming a convertible security with the fund pool by placing the funds of the fund pool in a trust paying at least one of an interest rate, a dividend and a periodic payment;
capitalizing an issuer by converting a first portion of the convertible security into one or more current ownership interests and one or more future ownership interests in a collateralized acquisition pool investment vehicle, and providing a second portion of funds held by the issuer;
engaging a management team to identify the assets for acquisition;
converting a second portion of the convertible security into further current ownership interests and further future ownership interests and providing a third amount of funds; and
acquiring one or more assets by exchanging at least a portion of the third amount of funds for the assets;
wherein the current ownership interests include at least one stock of the issuer trading on a securities market and the future interests include at least one warrant separable from the current ownership interest and trading on a securities market;
wherein the number of units of stock obtained by the converting is proportional to the number of units of the warrant based on the total number of units of the stock and the total number of units of the warrant; and
wherein the second amount of funds is disbursed for engaging a management team including paying the administrative expenses of the collateralized acquisition pool investment vehicle.

2. The method of claim 1, wherein the convertible security is converted to shares of common stock in the issuer and warrants exercisable for shares of common stock in the issuer.

3. The method of claim 1, wherein the convertible security is converted to a preferred security and warrants exercisable for shares of common stock in the issuer.

4. The method of claim 1, wherein the warrants are exercisable after a period of time and at an exercise price lower than an issue price of the common stock.

5. The method of claim 1, further comprising:
awarding the management team up to 20% of the common shares of the issuer after the acquiring.

6. The method of claim 5, wherein the awarding occurs after a predetermined period of time.

7. The method of claim 1, wherein the management team identifies one or more assets before the issuer is capitalized and before the management team is engaged.

8. The method of claim 1, wherein one unit of the warrant is issued for each unit of the stock.

9. The method of claim 1, wherein the asset is selected from the group consisting of a stock company, a limited liability company and a limited partnership.

10. The method of claim 1, wherein the issuer is a publicly traded stock company.

11. A collateralized acquisition pool investment vehicle, comprising:
an issuer;
one or more investors;
a management team;
an acquisition pool comprising at least one of (i) a portion of an amount of funds provided by the investors in exchange for one or more investor ownership interests in the collateralized acquisition pool investment vehicle, (ii) a convertible security, and (iii) one or more assets purchased with a portion of the amount of funds provided by the investors in exchange for the ownership interest; and
a plurality of ownership interests in the acquisition pool including the one or more current ownership interests and one or more future ownership interests,
wherein the issuer is a corporation having an issuer stock trading on a securities market at an issuer stock price;
wherein the convertible security is convertible to a current ownership interest at a conversion price upon occurrence of the first condition;
wherein the current ownership interests include a voting right and the future ownership interest changes to a current ownership interest upon occurrence of a second condition.

12. A collateralized acquisition pool investment vehicle asset acquisition method, comprising:
exchanging one or more ownership interests in a collateralized acquisition pool investment vehicle for a first amount of funds obtained from one or more investors;
converting a portion of the first amount funds in the collateralized acquisition pool investment vehicle to a current ownership interest owned by the investors and an operating amount of funds;
engaging a management team to identify one or more target assets for purchase by the collateralized acquisition pool investment vehicle;
identifying at least one target asset for purchase by the collateralized acquisition pool investment vehicle;
converting a further portion of the amount of funds to a current ownership interest and a future ownership interest owned by the investors and releasing the funds to the issuer;
purchasing the target asset with the funds released to the issuer.

13. A method for acquiring a plurality of assets, comprising:
(i) obtaining a first amount of funds from one or more investors and a management team,
wherein the first amount of funds is obtained from the investors and the management team in exchange for a current investor ownership interest, a current management team ownership interest, at least one future investor ownership interest and at least one future management team ownership interest,
wherein the current investor and current management team ownership interests each include at least one first convertible security and the future investor and the future management team ownership interests each include at least one warrant;
wherein the ownership interests are ownership interests in the first amount of funds or any asset obtained with any portion of the first amount of funds;
(ii) engaging the management team to identify the one or more assets and to assume control of an issuer;
(iii) capitalizing the issuer by transferring the first amount of funds to the issuer,
wherein the issuer is a publicly traded stock corporation and the amount of funds is held in a controlled account,
wherein the amount of funds is releasable to the issuer for at least one of a capital expenditure to acquire the one or more assets and the expenses of the management team,
wherein any release of the funds for a capital expenditure is conditioned on a majority affirmative vote of the current investor ownership interests;
(iv) exchanging a first portion of the future investor ownership interest for a second amount of funds provided by the management team, whereby the management team obtains a second future management team ownership interest from the investors;
(v) releasing a first issuer portion of the amount of funds in the controlled account to the issuer by converting a first portion of the first convertible security in a first conversion,
wherein the first conversion converts a first portion of the first convertible security to provide a second convertible security, and the first issuer portion of the funds is used to pay the expenses of the management team;
(vi) releasing a second issuer portion of the amount of funds in the controlled account to the issuer to purchase a first asset identified by the management team by converting a second portion of the first convertible security into a third convertible security,
wherein the second portion of issuer funds is released only after a first majority approval of the current ownership interests;
(vii) acquiring the first asset;
(viii) releasing a third issuer portion of the amount of funds in the controlled account to the issuer to purchase a second asset identified by the management team by converting a third portion of the first convertible security into a second portion of the third convertible security,
wherein the third portion of issuer funds is released only after a second majority approval of the current ownership interests; and
(vii) acquiring the second asset.

14. A method for acquiring one or more assets, comprising:
(i) engaging a management team to identify the one or more assets and to assume control of an issuer,
wherein the management team identifies the one or more assets before the engaging;
(ii) obtaining a first amount of funds from the management team, wherein the first amount of funds is obtained from the management team in exchange for a first current management team ownership interest and at least one first future management team ownership interest;
(iii) obtaining a second amount of funds from one or more investors,
wherein the second amount of funds is obtained from the investors in exchange for a current investor ownership interest and at least one future investor ownership interest,
wherein the current investor ownership interests and the current management team ownership interests each include at least one first convertible security, and the future investor ownership interests and the future management team ownership interests each include at least one warrant;
(iv) capitalizing the issuer by transferring the first amount of funds and the second amount of funds to the issuer,
wherein the issuer is a publicly traded stock corporation, and the first amount of funds and the second amounts of funds are held in a controlled account,
wherein the amount of funds is releasable to the issuer for at least one of a capital expenditure to acquire the one or more assets and the expenses of the management team,
wherein any release of funds for a capital expenditure is conditioned on a majority affirmative vote of the current investor ownership interests;
(v) releasing a first issuer portion of the funds in the controlled account to the issuer by converting a first portion of the first convertible security in a first conversion,
wherein the first conversion converts a first portion of the first convertible security to provide a first issuer portion of funds, and the first issuer portion of funds is used to pay the expenses of the management team;
(vi) releasing a second issuer portion of the funds in the controlled account to the issuer to purchase a first asset identified by the management team by converting a second portion of the first convertible security into a third convertible security in a second conversion,
wherein the second portion of issuer funds is released only after a majority approval of the current ownership interests; and
(vii) acquiring the first asset.

15. A method for acquiring one or more assets identified by a management team with a collateralized acquisition pool investment vehicle, comprising:
engaging a placement agent to obtain a first amount of funds from one or more investors to form a fund pool;
forming a convertible security with the fund pool by placing the funds of the fund pool in a trust paying at least one of an interest rate, a dividend and a periodic payment;
capitalizing an issuer by converting a first portion of the convertible security into one or more current ownership interests and one or more future ownership interests in a collateralized acquisition pool investment vehicle, and providing a second portion of funds held by the issuer;
converting a second portion of the convertible security into further current ownership interests and further future ownership interests and providing a third amount of funds; and
acquiring one or more assets by exchanging at least a portion of the third amount of funds for the assets;
wherein the current ownership interests include at least one stock of the issuer trading on a securities market and the future interests include at least one warrant separable from the current ownership interest and trading on a securities market;
wherein the number of units of stock obtained by the converting is proportional to the number of units of the warrant based on the total number of units of the stock and the total number of units of the warrant; and
wherein the second amount of funds is disbursed for engaging a management team including paying the administrative expenses of the collateralized acquisition pool investment vehicle.

16. The method of claim 15, wherein
the management team engages the placement agent,
the issuer is a public company, and
the capitalizing includes assigning at least a portion of the current ownership interests to the management team after the capitalizing.

17. The method of claim 15, further comprising:
at least one of merging a private entity with the issuer, acquiring a private entity with the issuer or having a private entity acquire the issuer;
wherein the private entity is formed by the management team,
the management team engages the placement agent, and
the issuer is a public company that is identified by the management team or the placement agent.

18. The method of claim 15, further comprising:
after the capitalizing, converting a private entity owned by the management team into a public company by filing a registration statement,
wherein the private entity is formed by the management team, and
the management team engages the placement agent.

19. The method of claim 15, wherein the placement agent is engaged by a private entity owned by the management team,
the management team identifies the issuer, and
the issuer is a public company,
the method further comprising:
at least one of merging the private entity with the issuer, acquiring the issuer with the private entity, and acquiring the private entity with the issuer.

20. The method of claim 15, wherein the placement agent is engaged by a private entity owned by the management team,
the management team identifies the issuer, and
the issuer is a public company,
the method further comprising:
after the capitalizing, converting the private entity into a public company by filing a registration statement.
